(19) United States
(12) Patent Application Publication
(10) Pub. No.: US 2026/0367106 A1
(43) Pub. Date: Nov. 19, 2026

(54) AUTOMATED CONTAINER SPIKING SYSTEM FOR CHEMICAL ANALYSES

(71) Applicant: Elemental Scientific, Inc., Omaha, NE (US)

(72) Inventors: Mason Spilinek, Omaha, NE (US); Austin Schultz, Omaha, NE (US)

(21) Appl. No.: 19/674,598

(22) Filed: May 12, 2026

Related U.S. Application Data
(60) Provisional application No. 63/805,589, filed on May 14, 2025.

(51) Int. Cl. G01N 35/10; G01N 35/00

(52) U.S. Cl. CPC G01N 35/1016; G01N 2035/00524; G01N 2035/1025

(57) ABSTRACT

Systems and methods for automated introduction of spiking fluids to an enclosed sample container are described. A system embodiment includes, but is not limited to, an enclosed sample container, the enclosed sample container including a container base, a container cap secured to the container base, and an integrated sample probe extending through the container cap to access an interior of the container base; a valve system; and a pump system fluidically coupled with each of the valve system and the integrated sample probe of the enclosed sample container, the pump system configured to introduce one or more spiking fluids to the interior of the container base through the integrated sample probe without prior removal of the container cap.

### CROSS-REFERENCE TO RELATED APPLICATIONS

The present application claims the benefit of 35 U.S.C. §119(e) of U.S. Provisional Application Serial No. 63/805,589, filed May 14, 2025, and titled “AUTOMATED BOTTLE SPIKING SYSTEM FOR CHEMICAL ANALYSES.” U.S. Provisional Application Serial No. 63/805,589 is herein incorporated by reference in its entirety.

### BACKGROUND

Inductively Coupled Plasma (ICP) spectrometry is an analysis technique commonly used for the determination of trace element concentrations and isotope ratios in liquid samples. ICP spectrometry employs electromagnetically generated partially ionized argon plasma which reaches a temperature of approximately 7 000K. When a sample is introduced to the plasma, the high temperature causes sample atoms to become ionized or emit light. Since each chemical element produces a characteristic mass or emission spectrum, measuring the spectra of the emitted mass or light allows the determination of the elemental composition of the original sample.

Sample introduction systems may be employed to introduce the liquid samples into the ICP spectrometry instrumentation (e.g., an Inductively Coupled Plasma Mass Spectrometer (ICP/ICP-MS), an Inductively Coupled Plasma Atomic Emission Spectrometer (ICP-AES), or the like) for analysis. For example, a sample introduction system may withdraw an aliquot of a liquid sample from a container and thereafter transport the aliquot to a nebulizer that converts the aliquot into a polydisperse aerosol suitable for ionization in plasma by the ICP spectrometry instrumentation. The aerosol generated by the nebulizer is then sorted in a spray chamber to remove the larger aerosol particles. Upon leaving the spray chamber, the aerosol is introduced into the plasma by a plasma torch assembly of the ICP-MS or ICP-AES instruments for analysis.

### SUMMARY

Systems and methods for automated introduction of spiking fluids to an enclosed sample container are described. In an aspect, a system embodiment includes, but is not limited to, an enclosed sample container, the enclosed sample container including a container base, a container cap secured to the container base, an integrated sample probe extending through the container cap to access an interior of the container base, and a vent port extending through the container cap to access the interior of the container base; a valve system including a first valve and a second valve fluidically coupled with the first valve via a fluid transfer line, the first valve fluidically coupled with each of the integrated sample probe and the vent port to control access to the interior of the container base; and a pump system fluidically coupled with each of the valve system and the integrated sample probe of the enclosed sample container, the pump system configured to introduce one or more spiking fluids to the interior of the container base through the integrated sample probe without prior removal of the container cap.

In an aspect, a system embodiment includes, but is not limited to, an enclosed sample container, the enclosed sample container including a container base, a container cap secured to the container base, and an integrated sample probe extending through the container cap to access an interior of the container base; a valve system; and a pump system fluidically coupled with each of the valve system and the integrated sample probe of the enclosed sample container, the pump system configured to introduce one or more spiking fluids to the interior of the container base through the integrated sample probe without prior removal of the container cap.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. In the figures, the use of the same reference numbers in different instances in the description and the figures may indicate similar or identical items.

FIG. 1 is a schematic diagram of an automated system for introducing spiking fluids to an enclosed sample container, in accordance with an embodiment of this disclosure.

FIG. 2 is a schematic diagram of the automated system of FIG. 1, shown in a sample analysis valve configuration to draw sample from the enclosed sample container, in accordance with an embodiment of this disclosure.

FIG. 3 is a schematic diagram of the automated system of FIG. 1, shown in a first spike fluid valve configuration to introduce a first spike fluid to the enclosed sample container, in accordance with an embodiment of this disclosure.

FIG. 4 is a schematic diagram of the automated system of FIG. 1, shown in a second spike fluid valve configuration to introduce a second spike fluid to the enclosed sample container, in accordance with an embodiment of this disclosure.

FIG. 5 is a schematic diagram of the automated system of FIG. 1, shown in a purge gas valve configuration to introduce gas into fluid lines to purge spike fluid from the fluid lines into the enclosed sample container, in accordance with an embodiment of this disclosure.

FIG. 6 is a schematic diagram of the automated system of FIG. 1, shown in a rinse valve configuration to introduce a rinse fluid through system fluid lines and the enclosed sample container to waste, in accordance with an embodiment of this disclosure.

FIG. 7 is a schematic diagram of the automated system of FIG. 1, shown in with a fill valve to facilitate loading of a pump of the pump system and priming of system fluid lines, in accordance with an embodiment of this disclosure.

### DETAILED DESCRIPTION

### Overview

Determination of trace elemental concentrations or amounts in a sample can provide an indication of purity of the sample, or an acceptability of the sample for use as a reagent, reactive component, or the like. For instance, in certain production or manufacturing processes (e.g., mining, metallurgy, semiconductor fabrication, pharmaceutical processing, etc.), the tolerances for impurities can be very strict, for example, on the order of fractions of parts per billion. In order to accurately measure trace elemental compositions for samples, the samples to be measured often require addition of one or more spiking fluids (e.g., internal standard materials, reactants, etc.) prior to analysis by ICP spectrometry instrumentation (an Inductively Coupled Plasma Mass Spectrometer (ICP/ICP-MS), an Inductively Coupled Plasma Atomic Emission Spectrometer (ICP-AES), or the like)) or other analytical instrumentation. However, addition of spiking fluids to a sample routinely involves removal of a cap, lid, or other covering from a sample vessel in order to introduce the spiking fluid. As the cap is removed, the interior of the sample vessel is generally exposed to the ambient environment, which can contaminate a sample, concentrate a sample (e.g., via sample evaporation), cause sample reactions (e.g., via chemical exposure, light exposure, etc.), or pose a safety hazard to laboratory staff. Manual cap removal, such as by laboratory staff, can be tedious and time inefficient to remove a cap prior to drawing a sample for analysis, even when an autosampler is used to introduce a sample probe to the interior of the manually-uncapped sample vessel.

Accordingly, the present disclosure is directed, at least in part, to systems and methods for automated introduction of one or more spiking fluids to a sample held in an enclosed sample container (e.g., a sample bottle with a cap thereupon) for analysis without removal of the cap to facilitate the introduction of the spiking fluids. In aspects, a system includes an enclosed sample container including an integrated sample probe and a vent port, with the enclosed sample container in fluid communication with a valve system and a pump system to introduce one or more spiking fluids to the enclosed sample container via the integrated sample probe. The vent port can be fluidically coupled with a valve configured to permit pressure to escape the interior of the sample vessel during fluid introduction, which can prevent over-pressurization of the enclosed sample container. Alternatively or additionally, the vent port can be fluidically coupled with a check valve to permit introduction of ambient gases into the interior of the sample vessel during fluid removal (e.g., via the integrated sample probe for sample analysis) to prevent collapse of the enclosed sample container caused by low pressure within the enclosed sample container.

In aspects, the system can introduce a first spiking fluid to assist with analyte recovery (e.g., nitric acid addition) and subsequently introduce a second spiking fluid, such as an internal standard as a calibration solution for sample analysis (e.g., to build a calibration curve). In aspects, the system can introduce a purge gas to system fluid lines to deliver the spiking fluids to the enclosed sample container while clearing the system fluid lines. The purge gas can be controlled by a mass flow controller (MFC), pressure regulator, or the like, or combinations thereof to prevent breaking up of the spiking fluid within the fluid lines (e.g., prevent bubble formation in the fluids lines). Alternatively or additionally, the system can introduce a working fluid (e.g., ultrapure water (UPW)) to the system fluid lines to push the spiking fluids or remnants thereof into the interior of the enclosed sample container through the integrated sample probe.

In aspects, the system includes a mass scale to record the mass of the enclosed sample container over time, which can track added fluid volumes, removed fluid volumes, and the like. The mass scale can be supported by an agitator, which can move the mass scale with the sample vessel (e.g., in a planar rotational motion) to mix the spiking fluids with the sample within the enclosed sample container prior to drawing the mixed sample from the enclosed sample container via the integrated sample probe for transfer to an analysis system to identify the presence, amount, or concentration of one or more analytes of interest within the fluid sample.

In aspects, the system can withdraw a portion of sample from the enclosed sample container via the integrated sample probe to analyze the contents of the sample prior to addition of spiking fluids to obtain a blank measurement for the sample. A second sample can be taken from the enclosed sample container after addition of one or more spiking fluids via the integrated sample probe to analyze the contents of the sample following spiking fluid addition, which can be compared against the blank measurement. Fluids can be removed from the from the enclosed sample container via the integrated sample probe through fluidic coupling of the valve system with a vacuum at the analysis system or through fluidic coupling of the valve system with a pump from the pump system.

In aspects, the system can determine a cleanliness of the enclosed sample container, such as with no sample contained therein, to evaluate a suitability of the enclosed sample container for use for subsequent sample analyses. The system can introduce a test fluid, such as ultrapure water (UPW) to the enclosed sample container via the integrated probe, where the test fluid continues to be added until a fluid level sensor measures a top surface of the fluid as it fills the interior of the sample vessel, upon which the flow of the test fluid is stopped. Alternatively or additionally, the mass scale can be used to determine an amount of test fluid within the enclosed sample container. The test fluid can then be spiked as desired and a portion removed and transferred to the analysis system for determination of the presence/amount of one or more analytes of interest to determine container cleanliness. The enclosed sample container can then be emptied of the test fluid to prepare the enclosed sample container for a subsequent sample. For example, the integrate probe can draw the test fluid from the interior of the enclosed sample container, where agitation of the enclosed sample container can facilitate removal of the remainder of the test fluid.

### Example Implementations

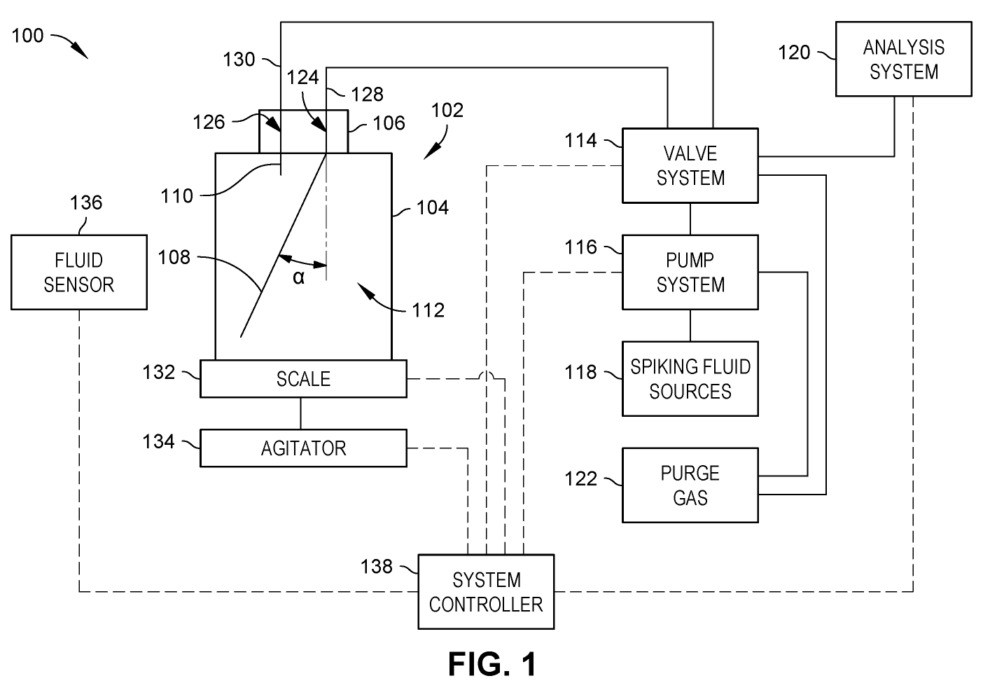

Referring generally to FIGS. 1-7, a system 100 is shown for automated introduction of one or more spiking fluids to an enclosed sample container, with or without a sample present therein, for analysis without removal of the cap to facilitate the introduction of the spiking fluids, in accordance with an example embodiment of the present disclosure. The system 100 is shown in FIG. 1 as generally including an enclosed sample container 102 (shown as a container base 104 (e.g., a bottle) having a cap 106 secured thereupon). The enclosed sample container 102 includes an integrated sample probe 108 and a vent port 110, each extending through the cap 106 to access an interior 112 of the enclosed sample container 102. The enclosed sample container 102 is fluidically coupled with a valve system 114 and a pump system 116 to introduce one or more spiking fluids from a spiking fluid source 118 to the interior 112 of the enclosed sample container 102 via the integrated sample probe 108. Fluid introduction can be facilitated through action of the pump system 116 or through a pressurized fluid source of the spiking fluid source 118. For example, the spiking fluid source 118 can include one or more includes including, but not limited to, an acid (e.g., nitric acid), a base, an internal standard, a calibration standard, a rinse fluid (e.g., ultrapure water (UPW)), or the like, and combinations thereof.

The system 100 can also introduce a purge gas from a purge gas source 122 to the interior 112 of the enclosed sample container 102 via the integrated sample probe 108, such as through action of the pump system 116, through introduction of pressurized purge gas to the valve system 114, or the like, or combinations thereof. In implementations, the purge gas is introduced through one or more portions of the fluid lines used to introduce the spiking fluid to the integrated sample probe 108 to transfer remnants of the spiking fluid that could remain within the fluid lines following cessation of operation of the pump system 116, as described further herein.

The pump system 116 can operate to draw sample from the enclosed sample container 102 and direct the sample through the valve system 114 to the analysis system 120 for determination of the presence/amount of one or more analytes of interest, described further herein. The analysis system 120 can include any system suitable for determination of one or analytes of interest in the sample, including, but not limited to, an inductively-coupled plasma analysis system (e.g., ICP-MS, ICP-AES, ICP-OES, etc.), an organic mass spectrometer, a gas chromatograph (GC), a liquid chromatograph (LC), a liquid chromatograph mass spectrometer (LC-MS), an ion chromatograph (IC), or another analytical instrument or technique to identify the presence, amount, or concentration of one or more analytes of interest within the fluid sample. In implementations, the pump system 116 includes a vacuum source positioned at the analysis system 120 to draw the sample from the enclosed sample container 102 through the valve system 114 and to the analysis system 120.

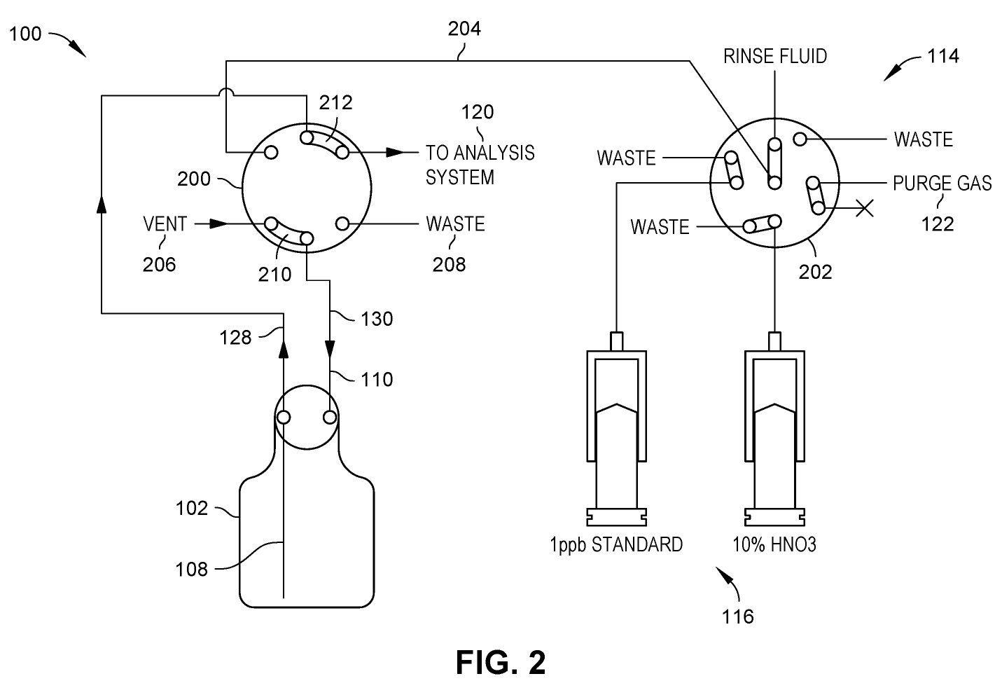

The enclosed sample container 102 can include any suitable shape of the container base 104 such that the cap 106 can be positioned on the container base 104 to provide a substantially sealed container to prevent the passage of liquids or gases out from or into the interior 112 unless through controlled passage through the cap 106 by one or more of the integrated sample probe 108 or the vent port 110. As described further herein, the controlled passage is facilitated by differing configurations of the valve system 114 to fluidically couple the integrated sample probe 108 within the interior 112 of the enclosed sample container 102 with the analysis system 120, with the spiking fluid sources 118, with the purge gas source 122, with a vent, with a waste outlet, or the like. The cap 106 can be secured to the container base 104 according to any suitable mechanism, including, but not limited to, a threaded arrangement, friction fit, or the like, or combinations thereof. The cap 106 is shown in FIG. 2 defining a first aperture 124 and a second aperture 126 through the cap 106 to provide a pathway through the cap 106 into the interior 112 of the enclosed sample container 102. The first aperture 124 permits the integrated sample probe 108 or a fluid line 128 coupled thereto to pass through the cap 106, whereas the second aperture 126 defines the vent port 110 or permits a fluid line 130 coupled thereto to pass through the cap 106, however the system 100 is not limited to such configuration and can include a single aperture to permit passage of the integrated sample probe 108, the vent port 110, and/or the fluid lines 128, 130. In implementations, the enclosed sample container 102 is formed from a chemical-resistant material to hold a variety of sample types within the interior 112. For example, the enclosed sample container 102 can be formed from or include perfluoroalkoxy alkane (PFA), polytetrafluoroethylene (PTFE), another material, or combinations thereof.

The system 100 is shown including a mass scale 132 supporting the enclosed sample container 102 to measure and record the mass of the enclosed sample container 102. For instance, the system 100 can measure the mass of the enclosed sample container 102 at any given time, on a continuous basis, at predetermined internals for a given time period, or the like, to facilitate tracking of added fluid volumes, removed fluid volumes, and the like. The mass scale 132 is shown supported by an agitator 134, which can move the mass scale 132 with the enclosed sample container 102 to mix the spiking fluids with the sample within the enclosed sample container 102, such as to provide a substantially uniform or homogenous mixture of sample and spiking fluids, or of the sample without any spiking fluids added (e.g., prior to taking a blank measurement). For example, the agitator 134 can include, but is not limited to, a support plate driven by a motor about a planar rotational motion to maintain the vertical positioning of the integrated sample probe 108 within the interior 112 while mixing the fluid held within the enclosed sample container 102. Alternatively, the mass scale 132 can support the agitator 134 which in turn supports the enclosed sample container 102.

The system 100 is also shown including a fluid sensor 136 to monitor a level of fluid within the interior 112 of the enclosed sample container 102, such as to facilitate automated filling operations or fluid removal. The fluid sensor 136 can include, but is not limited to, an optical sensor, an ultrasonic sensor, or the like, or combinations thereof to provide a sense signal indicative of the presence of a top fluid surface of fluid added to or removed from the interior 112 of the enclosed sample container 102 via the integrated sample probe 108.

The system 100 is also shown including a system controller 138 communicatively coupled with one or more of the components of the system 100, for example, to automatically control and coordinate operations of one or more of the pump system 116, the valve system 114, the fluid sensor 136, and the analysis system 120, to facilitate the operations described herein. For instance, the system controller 138 can instruct the valve system 114 to manipulate the configuration of respective valves of the valve system 114 to direct the flow of fluids within the system 100 through control of the pump system 116 or by permitting fluid communication with pressurized fluid sources (e.g., the purge gas source 122, rinse fluids of the spiking fluid sources 118, etc.).

Example configurations of the system 100 are shown with respect to FIGS. 2-7 to direct the flow of fluids within the system 100 to provide automated introduction of one or more spiking fluids to an enclosed sample container, with or without a sample present therein, for analysis without removal of the cap on the enclosed sample container. Referring to FIG. 2, the system 100 is shown with the valve system 114 in a sample analysis valve configuration to draw sample from the enclosed sample container 102 for detection of one or more analytes of interest by the analysis system 120. For example, the valve system 114 is shown including a first valve 200 fluidically coupled to a second valve 202 via a fluid transfer line 204. The first valve 200 is fluidically coupled to the integrated sample probe 108 within the enclosed sample container 102 via the fluid line 128 and to the vent port 110 via the fluid line 130. The first valve 200 is also shown fluidically coupled to a vent 206 and to a waste outlet 208 to facilitate control of the internal pressure of the enclosed sample container 102 during fluid introduction and removal. For example, the first valve 200 can include a channel 210 (e.g., positioned on a rotor or stator of the valve) to alternately couple the fluid line 130 with the vent 206 and the waste outlet 208. In implementations, the vent 206 can include an aperture open to the ambient atmosphere of the system 100 to permit the flow of ambient gases into the first valve 200 and the enclosed sample container 102 via the vent port 110 and the waste outlet 208 can include any container suitable for holding fluids received from the vent port 110 via the fluid line 130, such as to prevent overflow of the enclosed sample container 102 or to receive purge gas. In implementations, the vent port 110 is fluidically coupled with a check valve oriented to permit the introduction of ambient gases into the interior 112 during fluid removal (e.g., via the integrated sample probe 108 for sample analysis) to prevent collapse of the enclosed sample container 102 caused by low pressure within the interior 112.

Since the enclosed sample container 102 remains sealed during operation of the system 100 (e.g., with the cap 106 fixed on the container base 104), addition or removal of fluids from the interior 112 would otherwise change the internal pressure of the enclosed sample container 102 without fluidic coupling to the vent 206 for permitting gaseous entry into the interior 112 (e.g., during fluid removal from the bottle) or without fluidic coupling to the waste outlet 208 for permitting fluid release from the interior 112 (e.g., during fluid addition to the interior 112). For instance, without fluidic coupling with the vent 206 or the waste outlet 208, the addition or removal of fluids from the interior 112 could result in container collapse (e.g., due to removal of fluids and corresponding reduction in internal pressure) or container over-pressurization or rupture (e.g., due to addition of fluids and corresponding increase in internal pressure). Control of the configuration of the first valve 200 (e.g., via the system controller 138) ensures that the appropriate pressure relief, either the vent 206 or the waste outlet 208, is fluidically coupled to the fluid line 130 during fluid removal (e.g., in the sample analysis valve configuration) or addition (e.g., as described further herein).

With the system 100 in the sample analysis valve configuration, the first valve 200 fluidically couples the integrated sample probe 108 and associated fluid line 128 with the analysis system 120 (e.g., via valve channel 212). In implementations, the analysis system 120 includes a vacuum to pull sample from within the interior 112 into the integrated sample probe 108 and out of the enclosed sample container 102 through the fluid line 128 and the first valve 200 to the analysis system 120 for analytic detection of one or more analytes of interest in the sample. In implementations, the system controller 138 engages operation of the agitator 134 during fluid removal to move fluid within the interior 112 of the enclosed sample container 102, such as to bring fluid within an area of influence of the vacuum at the end of the integrated sample probe 108 to draw the sample into the integrated sample probe 108. For example, the integrated sample probe 108 can be at an angled orientation within the interior 112 (e.g., shown in FIG. 1 as an angle α displaced from a vertical axis) where horizontal planar rotation of the enclosed sample container 102 by the agitator 134 can push fluid towards the bottom edge of the container base 104, closer to the end of the integrated sample probe 108 to assist with complete fluid removal. In implementations, the angle displaced from vertical is from about 5 degrees to about 60 degrees, where the angle can generally depend on the dimensions of the container base 104, the positioning of the cap 106, and the like.

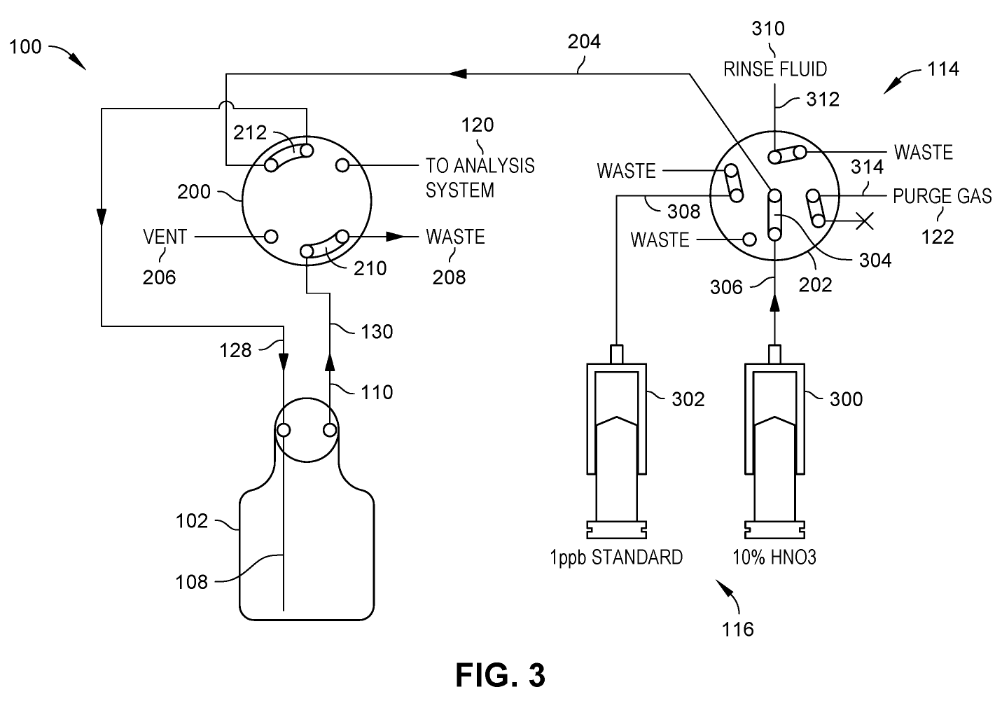

Referring to FIG. 3, the system 100 is shown with the valve system 114 in a first spike fluid valve configuration to introduce a first spike fluid to the enclosed sample container 102. In the first spike fluid valve configuration the first valve 200 fluidically couples the integrated sample probe 108 and corresponding fluid line 128 with the fluid transfer line 204 between the first valve 200 and the second valve 202. The first valve 200 also fluidically couples the vent port 110 with the waste outlet 208. In the first spike fluid valve configuration the second valve 202 fluidically couples a pump of the pump system 116 with the fluid transfer line 204 to permit introduction of the spiking fluid through the valve system 114 to the interior 112 of the container base 104. For example, the pump system 116 is shown including a first pump 300 to introduce a first spike fluid into the valve system 114 and a second pump 302 to introduce a second spike fluid into the valve system 114. The spike fluids can include a variety of chemicals for introduction to the enclosed sample container 102 or to sample or other fluid held within the enclosed sample container 102. The spike fluids can include, but are not limited to, an acid (e.g., nitric acid), a base, an internal standard, a calibration standard, a rinse fluid (e.g., ultrapure water (UPW)), or the like, and combinations thereof. For example, the first spike fluid is shown as nitric acid (e.g., 10% HNO₃) to assist with elemental recovery of analytes at the analysis system 120 and the second spike fluid is shown as an internal standard (e.g., a 1ppb standard) for calibration of analysis of the sample.

While the first pump 300 and the second pump 302 are diagrammatically illustrated as syringe pumps, the system 100 is not limited to such configuration and can include any suitable pump design for transferring fluids through the system 100. For example, the pump system 116 can include any combination of syringe pumps, peristaltic pumps, diaphragm pumps, or the like. In an implementation, each of the first pump 300 and the second pump 302 is a syringe pump to facilitate precise volumes of fluid transfer.

In the first spike fluid valve configuration the second valve 202 is shown fluidically coupling the first pump 300 with the fluid transfer line 204 via a selection channel 304 to permit introduction of the first spike fluid through the fluid transfer line 204 into the first valve 200 and to the fluid line 128 for passage into the integrated sample probe 108 within the interior 112 of the container base 104. In implementations, the second valve 202 manipulates the configuration of the selection channel 304 to selectively couple one of multiple fluid sources with the fluid transfer line 204 (e.g., via rotor and stator positioning through operation by a valve actuator under control by the system controller 138). For example, the second valve 202 can selectively couple the fluid transfer line 204 with any one of the first pump 300 (e.g., via a fluid line 306), the second pump 302 (e.g., via a fluid line 308), a rinse fluid source 310 (e.g., via a fluid line 312), and the purge gas source 122 (e.g., via a fluid line 314). In the first spike fluid valve configuration the second valve 202 selectively couples the first pump 300 with the fluid transfer line 204 where the first pump 300 pushes the first spike fluid to the integrated sample probe 108.

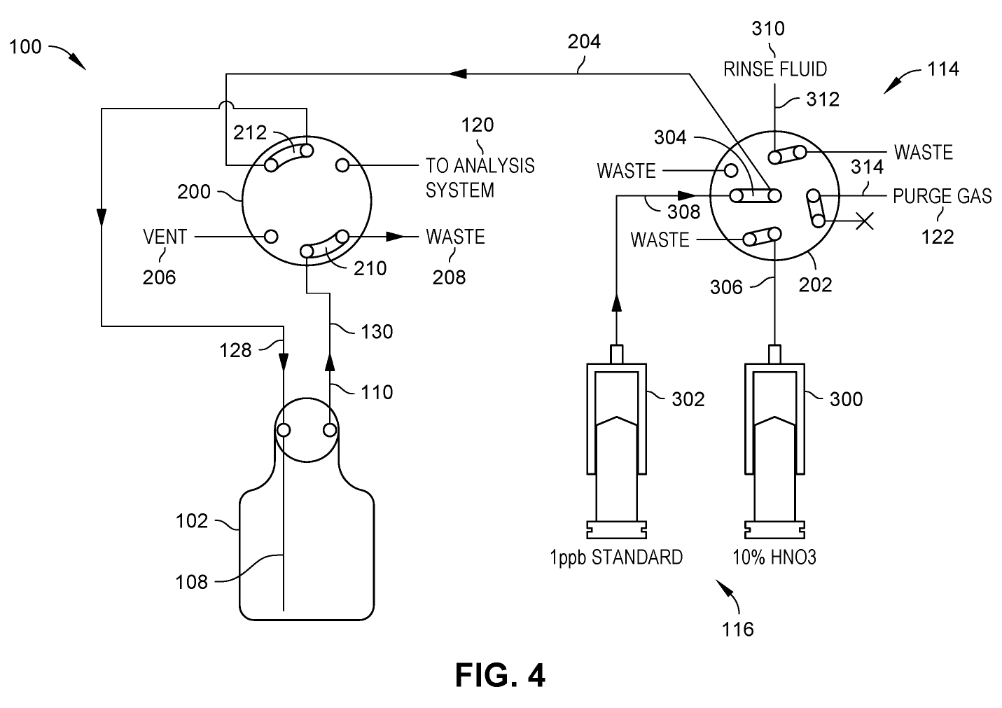

Referring to FIG. 4, the system 100 is shown in a second spike fluid valve configuration to introduce a second spike fluid to the enclosed sample container. In the second spike fluid valve configuration the first valve 200 adopts the same configuration as with the first spike fluid valve configuration by fluidically coupling the integrated sample probe 108 and corresponding fluid line 128 with the fluid transfer line 204 also fluidically coupling the vent port 110 with the waste outlet 208. In the second spike fluid valve configuration the second valve 202 is shown fluidically coupling the second pump 302 with the fluid transfer line 204 via the selection channel 304 to permit introduction of the second spike fluid (e.g., a calibration standard or internal standard) through the fluid transfer line 204 into the first valve 200 and to the fluid line 128 for passage into the integrated sample probe 108 within the interior 112 of the container base 104.

Following or during introduction of either or both spiking fluids, the agitator 134 can activate to planarly rotate the enclosed sample container 102, such as to mix the spiking fluid or fluids into the sample. In implementations, the system 100 measures and tracks the amount of fluid added to the enclosed sample container 102 through operation of the scale 132 during fluid addition or prior to and subsequent to fluid addition. For instance, the system controller 138 can direct the mass scale 132 to take an initial measurement of the mass of the enclosed sample container 102 prior to spike fluid introduction (e.g., with the container base 104 empty or holding sample) and to take a subsequent measurement of the mass of the enclosed sample container 102 following introduction of the spike fluid. Alternatively or additionally, the system controller 138 can direct the mass scale 132 to take continuous or periodic measurements of the mass of the enclosed sample container 102 to track the mass over time.

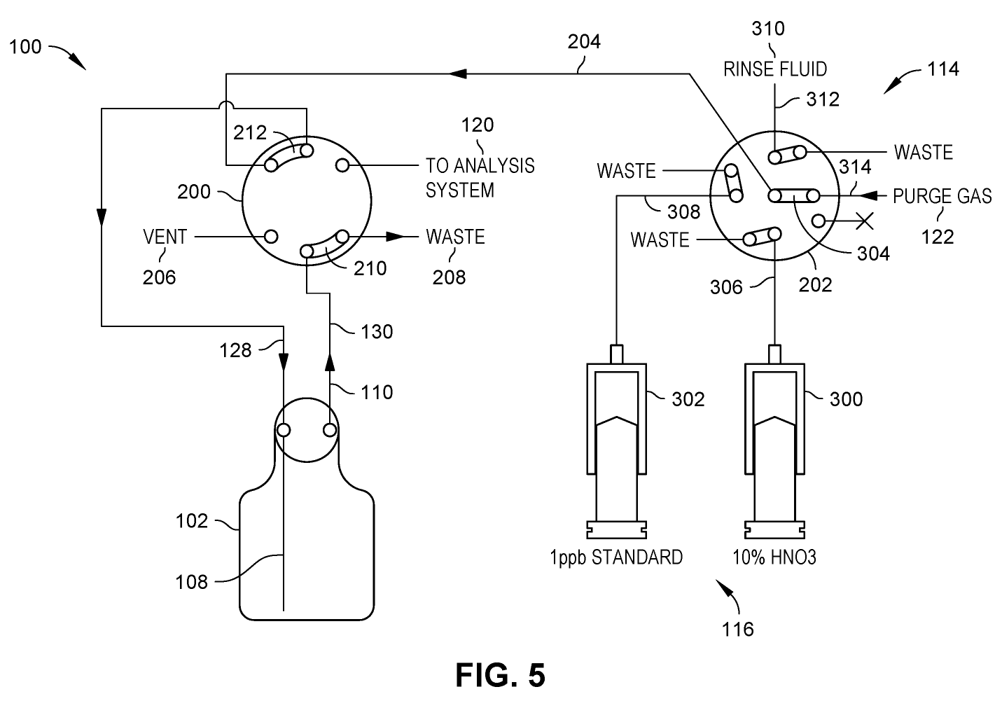

Referring to FIG. 5, the system 100 is shown in a purge gas valve configuration to introduce gas into fluid lines and valves to purge spike fluid from the fluid lines and valves into the enclosed sample container 102. For instance, following introduction of the first spiking fluid and/or the second spiking fluid, a portion of the spiking fluid can be positioned between the valve and the enclosed sample container. For example, for syringe pump operation of the first pump 300 or the second pump 302, as the plunger is depressed into the syringe to dispense the desired volume of spike fluid towards the integrated sample probe 108, spike fluid may be present in one or more of the fluid transfer line 204, the second valve 202 (e.g., within the selection channel 304), the first valve 200 (e.g., within the valve channel 212), the fluid line 128, and the integrated sample probe 108. The remainder of this spiking fluid can be pushed into the interior 112 of the enclosed sample container 102 via the integrated sample probe 108 using a pressurized purge gas. For example, in the purge gas valve configuration the first valve 200 adopts the same configuration as with the first spike fluid valve configuration and the second spike fluid valve configuration by fluidically coupling the integrated sample probe 108 and corresponding fluid line 128 with the fluid transfer line 204 and also fluidically coupling the vent port 110 with the waste outlet 208. In the purge gas valve configuration the second valve 202 is shown fluidically coupling the purge gas source 122 with the fluid transfer line 204 via the selection channel 304 to permit introduction of the purge gas (e.g., nitrogen, air, inert gas, etc.) through the fluid transfer line 204 into the first valve 200 and to the fluid line 128 for passage into the integrated sample probe 108 within the interior 112 of the container base 104 whereby the purge gas pushes residual spike fluid into the enclosed sample container 102. During delivery of the purge gas, the first valve 200 fluidically couples the vent port 110 with the waste outlet 110 so the enclosed sample container 102 does not overly pressurize during purge gas addition.

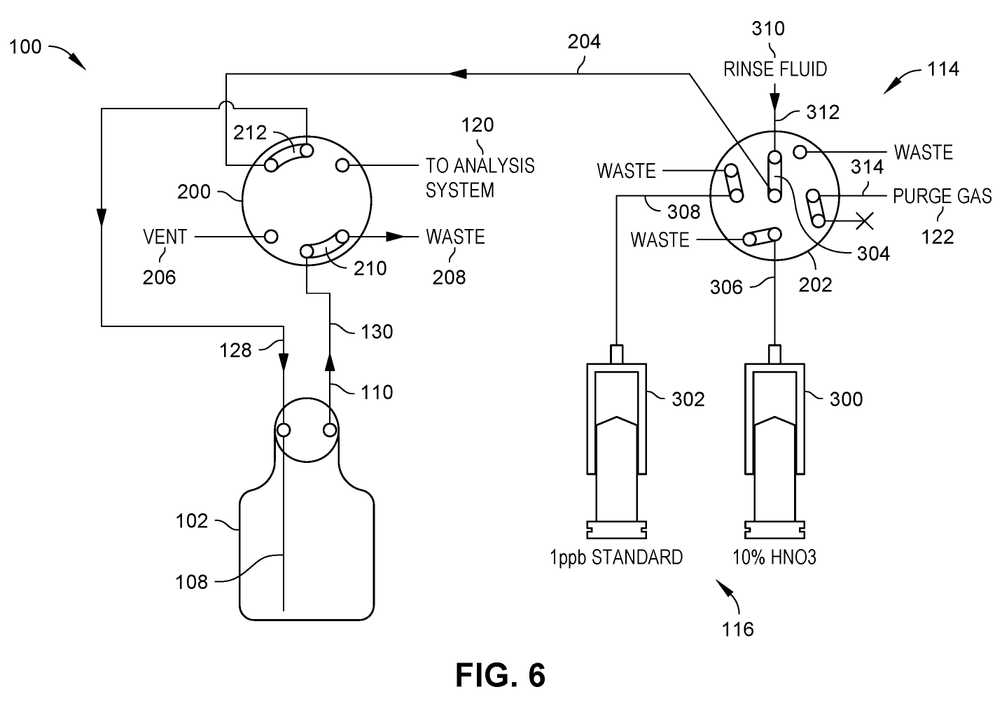

Alternatively or additionally to introduction of a purge gas into the fluid lines of the system 100, a rinse fluid (e.g., UPW) can be flushed through the system lines to introduce the remainder of the spiking fluid to the interior 112 of the enclosed sample container 102 via the integrated sample probe 108. For example, referring to FIG. 6, the system 100 is shown in a rinse valve configuration to introduce a rinse fluid through system fluid lines and into the enclosed sample container 102. For example, in the rinse valve configuration the first valve 200 adopts the same configuration as with the purge gas valve configuration by fluidically coupling the integrated sample probe 108 and corresponding fluid line 128 with the fluid transfer line 204 and also fluidically coupling the vent port 110 with the waste outlet 208. In the rinse valve configuration the second valve 202 is shown fluidically coupling the rinse fluid source 310 with the fluid transfer line 204 via the selection channel 304 to permit introduction of the rinse fluid (e.g., water, ultrapure water, etc.) through the fluid transfer line 204 into the first valve 200 and to the fluid line 128 for passage into the integrated sample probe 108 within the interior 112 of the container base 104 whereby the rinse fluid pushes residual spike fluid into the enclosed sample container 102. During delivery of the rinse fluid, the first valve 200 fluidically couples the vent port 110 with the waste outlet 110 so the enclosed sample container 102 does not overly pressurize during rinse fluid addition.

In implementations, the rinse fluid is added to the enclosed sample container 102 to permit the rinse fluid to overflow the enclosed sample container 102 and exit via the vent port 110 to waste, such as during a rinsing or cleaning operation for the enclosed sample container 102 between sample analyses. Following or during introduction of the spiking fluid via the purge gas and/or the rinse fluid, the agitator 134 can mix the spiking fluid into the sample, whereby a sample can then be removed from the enclosed sample container 102 via the integrated sample probe 108 for transfer to the analysis system 120 for analysis.

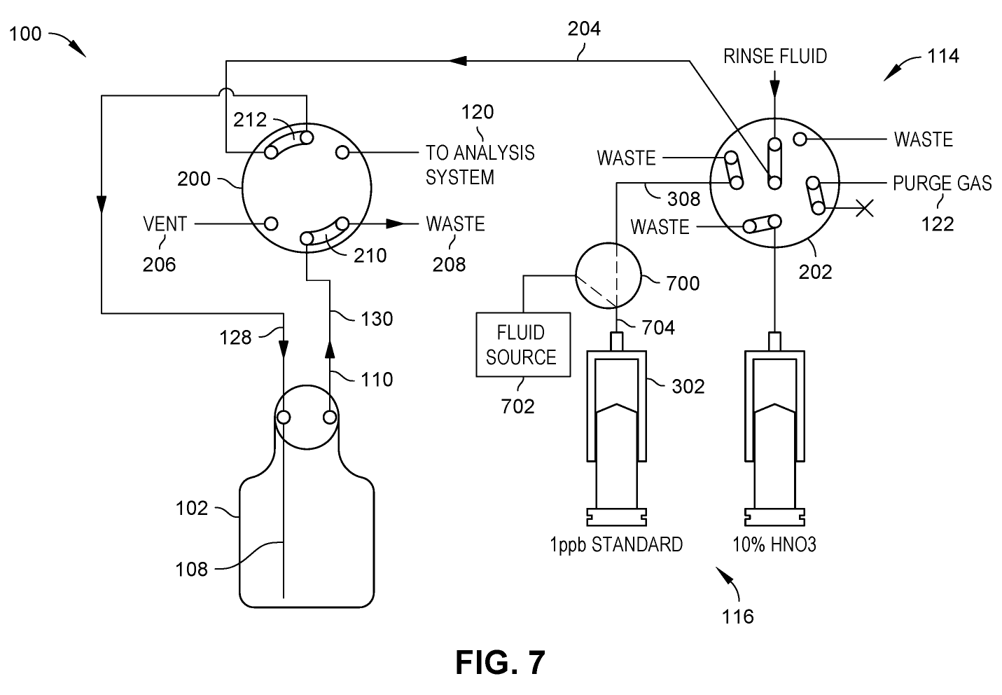

The system 100 can facilitate transfer of spike fluids by priming fluid lines within the system 100 prior to transfer to the integrated sample probe 108. For example, referring to FIG. 7, the system 100 is shown including a fill valve 700 fluidically coupled between the second pump 302 and the second valve 202. The fill valve 700 facilitates loading of the second pump 302 with fluid, such as between sample analyses or with additional spike fluid following a number of spikes where replenishment of a volume of spike fluid is needed or scheduled. The fill valve 700 can selectively transition between a load configuration and a dispense configuration, such as under control by the system controller 138 to coordinate filling and dispensing operations of the pump system 116. In the load configuration, the fill valve 700 fluidically couples the second pump 302 and a fluid source 702 (e.g., a spike fluid source, such as a container of internal standard) to permit the second pump 302 to pull the plunger to fill with a desired volume of spike fluid. In the dispense configuration, the fill valve 700 fluidically couples the second pump 302 with the second valve 202 to permit the second pump 302 to dispense spike fluid into the second valve 202. In implementations, the second pump 302 can initially dispense spike fluid to waste to fill the fluid lines between the second pump 302 and the second valve 202 (e.g., fluid lines 308, 704). When the system 100 transitions to the second spike fluid valve configuration, the operation of the second pump 202 can immediately begin transferring the second spike fluid to the fluid transfer line 204 since no voids or air bubbles are present in the fluid lines therebetween, to provide a precise and corresponding delivery of spike through according to depression of the plunger. In a similar manner, the system can include a separate or same fill valve to fluidically couple the first pump can include with its own respective fluid source (not shown) to facilitate fluid line priming before transfer of the first spike fluid.

Electromechanical devices (e.g., electrical motors, servos, actuators, or the like) may be coupled with or embedded within components of the system 100 (e.g., the valves, the syringe pumps, and combinations thereof) to facilitate automated operation via control logic embedded within or externally driving the system 100, coordinated by the system controller 138. The electromechanical devices can be configured to cause the plurality of valves to direct fluid flows from syringes, valves, flow paths, etc., according to one or more modes of operation, such as those described herein. The system 100 may include or be controlled by a computing system having a processor configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the valve system 114, the pump system 116, and any of the various components described herein. The program instructions, when executing by the processor, can cause the computing system to control the system 100 (e.g., control the pumps and selection valves) according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### Conclusion

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. An automated system for introducing spiking fluids to an enclosed sample container, comprising:
an enclosed sample container, the enclosed sample container including
a container base,
a container cap secured to the container base,
an integrated sample probe extending through the container cap to access an interior of the container base, and
a vent port extending through the container cap to access the interior of the container base;
a valve system including a first valve and a second valve fluidically coupled with the first valve via a fluid transfer line, the first valve fluidically coupled with each of the integrated sample probe and the vent port to control access to the interior of the container base; and
a pump system fluidically coupled with each of the valve system and the integrated sample probe of the enclosed sample container, the pump system configured to introduce one or more spiking fluids to the interior of the container base through the integrated sample probe without prior removal of the container cap.

2. The automated system of claim 1, wherein the valve system includes a sample analysis valve configuration that fluidically couples the integrated sample probe with an analysis system to permit transfer of fluid from the interior of the container base to the analysis system for determination of a concentration of one or more analytes within the fluid, and wherein the sample analysis valve configuration fluidically couples the vent port with a vent open to atmosphere.

3. The automated system of claim 1, wherein the valve system includes a purge gas valve configuration that fluidically couples the integrated sample probe with a pressurized purge gas source to transfer purge gas and residual fluid to the interior of the container base, and wherein the purge gas valve configuration fluidically couples the vent port with a vent open to atmosphere to release purge gas from the interior of the container base.

4. The automated system of claim 3, wherein the purge gas valve configuration includes the first valve in a configuration that fluidically couples the integrated sample probe with the fluid transfer line and fluidically couples the vent port with the vent, and wherein the purge gas valve configuration includes the second valve in a configuration that fluidically couples the pressurized purge gas source with the fluid transfer line to permit introduction of the purge gas to the interior of the container base.

5. The automated system of claim 1, wherein the valve system includes a spike fluid valve configuration that fluidically couples the integrated sample probe with a pump of the pump system to transfer a spiking fluid through the valve system to the interior of the container base through the integrated sample probe, and wherein the spike fluid valve configuration fluidically couples the vent port with a waste outlet fluidically coupled with the valve system.

6. The automated system of claim 5, wherein the spike fluid valve configuration includes the first valve in a configuration that fluidically couples the integrated sample probe with the fluid transfer line and fluidically couples the vent port with the waste outlet, and wherein the spike fluid valve configuration includes the second valve in a configuration that fluidically couples the pump of the pump system with the fluid transfer line to permit introduction of the spiking fluid through the valve system to the interior of the container base.

7. The automated system of claim 1, wherein the valve system includes a rinse valve configuration that fluidically couples the integrated sample probe with a source of rinse fluid to transfer rinse fluid through the valve system to the interior of the container base through the integrated sample probe, wherein the rinse valve configuration fluidically couples the vent port with a waste outlet fluidically coupled with the valve system.

8. The automated system of claim 7, wherein the rinse valve configuration includes the first valve in a configuration that fluidically couples the integrated sample probe with the fluid transfer line and fluidically couples the vent port with the waste outlet, and wherein the rinse valve configuration includes the second valve in a configuration that fluidically the source of rinse fluid with the fluid transfer line to permit introduction of the rinse fluid through the valve system to the interior of the container base.

9. The automated system of claim 7, further comprising a fluid sensor and a system controller communicatively coupled with the fluid sensor and the valve system, the system controller configured to set the valve system in the rinse valve configuration to introduce rinse fluid to the interior of the container base, wherein upon detection of a presence of the rinse fluid by the fluid sensor within the interior of the container base, the system controller instructs the valve system to transition to a filled valve configuration that fluidically decouples the integrated sample probe with the rinse fluid to obtain a predetermined volume of fluid within the interior of the container base.

10. The automated system of claim 1, further comprising a scale positioned to support the enclosed sample container and to weigh the enclosed sample container for mass tracking of fluid added to or removed from the enclosed sample container.

11. The automated system of claim 10, further comprising an agitator coupled with the scale to move the scale for mixing of fluids held within the enclosed sample container.

12. An automated system for introducing spiking fluids to an enclosed sample container, comprising:
an enclosed sample container, the enclosed sample container including
a container base,
a container cap secured to the container base, and
an integrated sample probe extending through the container cap to access an interior of the container base;
a valve system including a plurality of valve configurations to selectively permit and prevent fluid access to the integrated sample probe; and
a pump system fluidically coupled with each of the valve system and the integrated sample probe of the enclosed sample container, the pump system configured to introduce one or more spiking fluids to the interior of the container base through the integrated sample probe without prior removal of the container cap.

13. The automated system of claim 12, wherein the valve system includes a sample analysis valve configuration that fluidically couples the integrated sample probe with an analysis system to permit transfer of fluid from the interior of the container base to the analysis system for determination of a concentration of one or more analytes within the fluid.

14. The automated system of claim 12, further comprising a vent port extending through the container cap to access the interior of the container base.

15. The automated system of claim 14, wherein the valve system includes a purge gas valve configuration that fluidically couples the integrated sample probe with a pressurized purge gas source to transfer purge gas and residual fluid to the interior of the container base, and wherein the purge gas valve configuration fluidically couples the vent port with a vent open to atmosphere to release purge gas from the interior of the container base.

16. The automated system of claim 14, wherein the valve system includes a spike fluid valve configuration that fluidically couples the integrated sample probe with a pump of the pump system to transfer a spiking fluid through the valve system to the interior of the container base through the integrated sample probe, and wherein the spike fluid valve configuration fluidically couples the vent port with a waste outlet fluidically coupled with the valve system.

17. The automated system of claim 14, wherein the valve system includes a rinse valve configuration that fluidically couples the integrated sample probe with a source of rinse fluid to transfer rinse fluid through the valve system to the interior of the container base through the integrated sample probe, wherein the rinse valve configuration fluidically couples the vent port with a waste outlet fluidically coupled with the valve system.

18. The automated system of claim 17, further comprising a fluid sensor and a system controller communicatively coupled with the fluid sensor and the valve system, the system controller configured to set the valve system in the rinse valve configuration to introduce rinse fluid to the interior of the container base, wherein upon detection of a presence of the rinse fluid by the fluid sensor within the interior of the container base, the system controller instructs the valve system to transition to a filled valve configuration that fluidically decouples the integrated sample probe with the rinse fluid to obtain a predetermined volume of fluid within the interior of the container base.

19. The automated system of claim 12, further comprising a scale positioned to support the enclosed sample container and to weigh the enclosed sample container for mass tracking of fluid added to or removed from the enclosed sample container.

20. The automated system of claim 19, further comprising an agitator coupled with the scale to move the scale for mixing of fluids held within the enclosed sample container.
